(19) United States
(12) Patent Application Publication
(10) Pub. No.: US 2015/0107965 A1
(43) Pub. Date: Apr. 23, 2015

(54) SCREW ELEMENT FOR A SCREW CONVEYOR

(71) Applicant: SANTOBIN PTY LTD, Bundaberg, Queensland (AU)

(72) Inventor: Kim John Blacker Price, Bundaberg, Queensland (AU)

(21) Appl. No.: 14/381,477

(22) PCT Filed: Feb. 27, 2013
(86) PCT No.: PCT/AU2013/000180

§ 371 Date: Aug. 27, 2014

(30) Foreign Application Priority Data
Feb. 28, 2012 (AU) 2012900776

(51) Int. Cl. B65G 33/32; B65G 33/14; B65G 33/26

(52) U.S. Cl. CPC B65G 33/32; B65G 33/26; B65G 33/14
USPC 198/657

(57) ABSTRACT

A screw element for a screw conveyor, said screw element comprising a hub portion having a generally circular bore axially therethrough, and a spiral flight portion extending around said hub in a generally helical path; characterised in that said element comprises engagement means at each axial end thereof for mating with an adjacent element whereby torque may be transmitted between two or more adjacent screw elements via said engagement means.

### FIELD

The present disclosure relates to a screw element for a screw conveyor, and also to a conveyor of modular screw element construction.

### BACKGROUND

Screw conveyors normally comprise an auger operating within a tube. Such screw conveyors are widely used as means for transporting particulate and powdered material, such as grain, chemicals and coal dust. Screw conveyors can also be used as pumps for liquids.

The screw conveyors are frequently required to operate over long lengths. In early forms of screw conveyors, the screw was fabricated by welding a helical flight section to a central hub. This method of construction was costly and cumbersome and could only be satisfactorily employed where the materials of the flights and the hub were weldable materials such as steel. Moreover, due to the unitary structure of the screw, it was necessary to remove the whole screw for servicing or repair.

In order to overcome the problems of screw conveyors of unitary construction, modular screw conveyors were developed. Australian patent no. 468608 disclosed a screw conveyor comprising a plurality of screw elements arranged end to end on a drive shaft. Torque was transmitted to each screw element individually by the shaft. To transmit the torque to the elements, the shaft was provided with a number of splines which engaged grooves formed in the axial bore of each screw element. The need to provide the splines on the shaft and the grooves in the screw elements increased the cost of manufacture of the screw conveyor. Australian design registration no. 84991 proposed a screw element of more economical design. Namely, the screw element comprised an axial bore of generally square cross section, thereby enabling the screw element to be used on a standard square section shaft. However, even square section shafts are relatively expensive, being of the order of three times the cost of round shafts or tubes. Prior art screw elements could not operate on round shafts however, since the shaft could not transmit torque to the screw element.

### SUMMARY

In one aspect, the present disclosure provides a screw element for a screw conveyor, said screw element comprising a hub portion having a generally circular bore axially therethrough, and a spiral flight portion extending around said hub in a generally helical path; wherein said element comprises engagement means at each axial end thereof for mating with an adjacent screw element, whereby torque may be transmitted serially between two or more screw elements via their respective engagement means.

Typically, the engagement means comprises complementary axial projections at opposite ends of the screw element such that the opposed ends of screw elements can lock together at least circumferentially. In the embodiment described hereinafter, the engagement means consist of castellated annular portions provided at opposite ends of the hub of each screw element, the castellated portions of opposed ends of adjacent screw elements being dimensioned for a snug fit.

The screw element may be formed of any suitable mouldable or castable material, such as plastics, ceramics, powdered metals or cast metals. In the preferred form, the screw element is made of moulded plastic.

Typically, the spiral flight on each element extends for one full turn. However, screw elements having a number of turns or a fraction of a turn are also within the scope of the present disclosure. In a screw conveyor in accordance with embodiments of the present disclosure, the screw elements are arranged axially along a round shaft, which may be a length of common pipe or round bar. The auger formed by the shaft-mounted screw elements is located within a tubular conveyor. Torque need only be provided to an end screw element, the torque then being transmitted serially to all the screw elements via the engagement means between adjacent elements.

The present disclosure provides screw conveyors which can be constructed at significantly lower costs than at least some prior art conveyors. Furthermore, servicing and repair of such conveyors is simplified since only the particular damaged element need be replaced. Where an element located in the middle of a long conveyor is to be replaced, it is only necessary to remove that element, e.g. by cutting it off, and then moving the elements to close the gap, a replacement element being added at the end of the conveyor.

### BRIEF DESCRIPTION OF THE DRAWINGS

Embodiments will now be described, by way of example only, with reference to the accompanying drawings, in which;

FIG. 1 is a perspective view of a screw element according to a preferred embodiment of the present disclosure;

FIG. 2 is an elevational view of two interlocking screw elements of FIG. 1; and

FIG. 3 is a sectional elevational view of a screw conveyor partially constructed using the screw element of FIG. 1.

### DETAILED DESCRIPTION

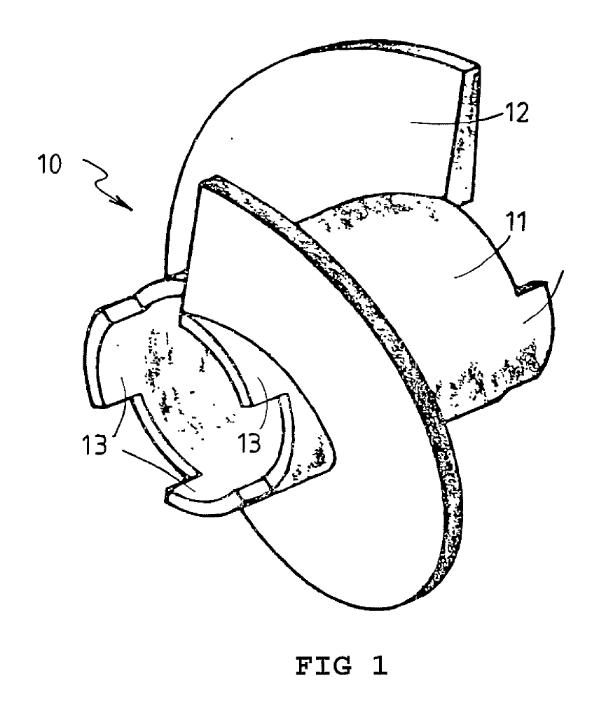

As shown in FIG. 1, the screw element 10 of the preferred embodiment comprises a generally cylindrical hub portion 11 having a round bore therethrough. A spiral flight 12 extends around the hub 11 in a helical path for one full turn. Preferably, the hub 11 and flight 12 are integrally moulded, e.g. of plastics material.

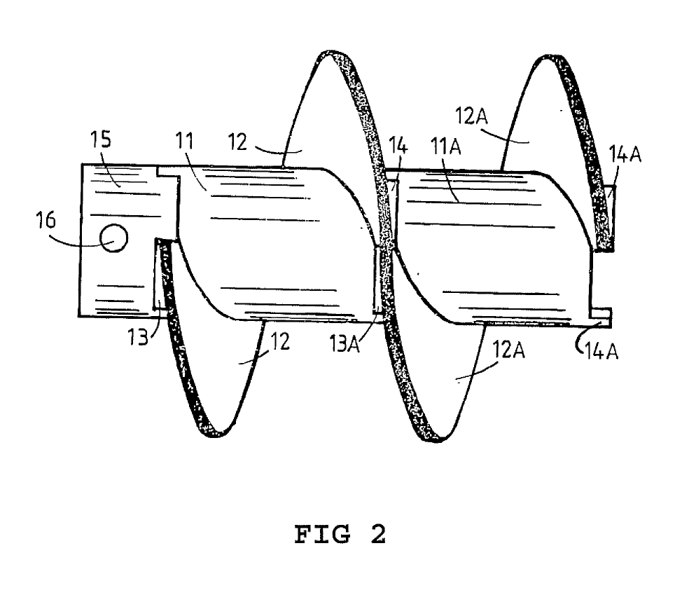

The axial ends of the hub are provided with engagement means for mating with the opposed ends of adjacent screw elements. The engagement means may be considered to be engagement portions or engagement regions of the hub. In the illustrated embodiment, the engagement means comprises a series of castellations 13, 14 at respective opposite ends of the hub 11. The castellations 13, 14 are of complementary configuration thereby enabling opposed ends of adjacent elements to mate as shown in FIG. 2. That is, the castellations 13A of an adjacent hub 11A will be received within the spaces between castellations 14. The flights 12 are provided with radial faces so that the composite flight 12, 12A will be continuous. In this manner, an auger can be made up of a number of screw elements.

An end element 15 may be provided, if required. The end element 15 includes a radial aperture 16 to enable the end element to be fastened to the shaft.

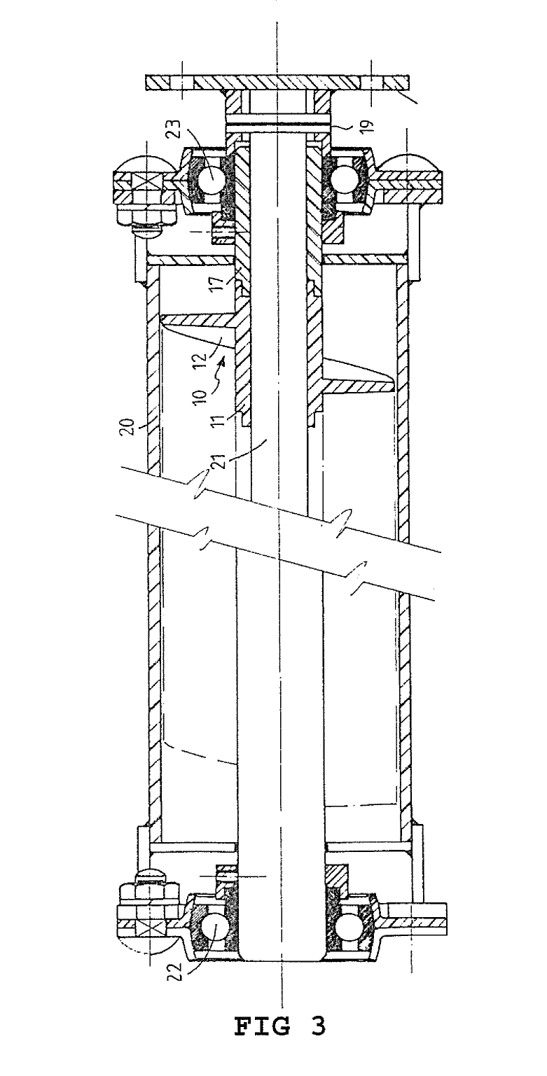

The screw elements 10 can be mounted on a round shaft 21, typically a length of round tube or pipe as shown in FIG. 3 to provide a screw conveyor constructed of modular screw elements mounted on a round shaft. The screw elements are located within a tubular conveyor housing 20 of the required length. The shaft 21 is mounted at its ends on bearings 22, 23. Any suitable means may be provided for rotating the composite auger formed by the screw elements. For example, a cog 18 may be provided around the end portion 17 shown in FIG. 3, the cog 18 being fixed circumferentially relative to the end portion 17 via a fastener through the aperture 19. Application of torque to cog 18, e.g. by chain drive, will rotate the end sleeve element 17 which, in turn, will transmit the torque to the screw elements sequentially to cause the composite screw to rotate about the shaft 21.

It will be apparent to those skilled in the art that the screw element of the present disclosure can reduce the costs of construction of screw conveyors. Further, the screw element of the present disclosure can facilitate flexibility of design, of screw conveyors, since (assuming an appropriate shaft is provided) screw conveyors formed of the disclosed screw elements can be can be made longer or shorter simply by adding or removing the appropriate number of screw elements.

The foregoing describes only one embodiment of the invention, and modifications which are obvious to those skilled in the art may be made thereto without departing from the scope of the invention. For example, the screw elements may be provided with a multiple number of turns, or a fraction of a turn, of the spiral flight. Furthermore, the engagement means may be in the form of a saw-tooth or corrugated edge rather than a castellated edge.

It is to be understood that, if any prior publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A screw element for a screw conveyor, said screw element comprising a hub portion having a generally circular bore axially therethrough, and a spiral flight portion extending around said hub in a generally helical path; wherein said element comprises engagement means at each axial end thereof for mating with an adjacent element whereby torque may be transmitted between two or more adjacent screw elements via said engagement means.

2. A screw element as claimed in claim 1, wherein said engagement means are located at opposite ends of the hub portion and comprise complementary axial projections.

3. A screw element as claimed in claim 2, wherein said engagement means comprise castellated annular portions at respective opposite axial ends of said hub.

4. A screw element as claimed in claim 1, wherein said spiral flight extends around said hub in one full turn.

5. A screw element as claimed in claim 1, wherein said screw element is constructed from integrally moulded plastics material.

6. A screw element as claimed in claim 1, wherein said screw element is formed of metal.

7. (canceled)

8. A screw conveyor comprising a tubular housing having an axial shaft therein, a plurality of screw elements serially connected along said shaft, said screw elements being rotatable about said shaft, wherein each said screw element comprises a hub portion having a generally circular axial bore in which said shaft is received, and a spiral flight portion extending around said hub in a generally helical path, each said element also comprising engagement means at each axial end thereof for mating with an adjacent element whereby torque may be transmitted between two or more adjacent screw elements via said engagement means .

9. A screw conveyor as claimed in claim 8, further comprising an end element mounted on said shaft, said end element being matingly connected to one of said screw elements, and means for applying torque to said end element .

10. A screw conveyor comprising one or more screw elements as claimed in claim 1.
